(19) United States
(12) Patent Application Publication
(10) Pub. No.: US 2026/0036779 A1
(43) Pub. Date: Feb. 5, 2026

(54) CABLE ASSEMBLY HAVING THERMOPLASTIC OVERMOLD

(71) Applicant: CORNING RESEARCH & DEVELOPMENT CORPORATION, Corning, NY (US)

(72) Inventors: Michael Todd Faulkner, Granite Falls, NC (US); Lars Kristian Nielsen, Denver, NC (US)

(21) Appl. No.: 19/356,503

(22) Filed: Oct. 13, 2025

Related U.S. Application Data
(63) Continuation of application No. PCT/US2024/027922, filed on May 6, 2024.
(60) Provisional application No. 63/469,583, filed on May 30, 2023.

(51) Int. Cl. G02B 6/44

(52) U.S. Cl. CPC G02B 6/4472

(57) ABSTRACT

A cable assembly in which a distribution cable contains a plurality of optical elements and has an opening formed in the distribution cable. A branch cable has a bore extending along a length thereof. At least one optical element of the plurality of optical elements extends from the distribution cable through the opening and into the bore of branch cable. A thermoplastic overmold is formed around the opening of the distribution cable, an end of the branch cable, and at least a portion of the at least one optical element. The thermoplastic overmold provides a strong connection to the distribution cable and the branch relative to a size of the overmold.

### CROSS-REFERENCE TO RELATED APPLICATION

This application is a continuation of Internation Patent Application No. PCT/US2024/027922, filed on May 6, 2024, which claims the benefit of priority of U.S. Provisional Application No. 63/469,583, filed on May 30, 2023, the content of which is relied upon and incorporated herein by reference in its entirety.

### BACKGROUND

The disclosure relates generally to an optical fiber distribution cable having a branch cable and more particularly to an overmold applied to a branch point along the optical fiber distribution cable. As optical fibers are routed through a network, they may be carried in smaller and smaller optical fiber cables. For example, a main distribution cable may include several hundreds or thousands of optical fibers, and optical fiber cables containing fewer optical fibers may branch off of the main distribution cable at various points along the length of the main distribution cable. At such branching points, the branching cables may be protected with a molding material. However, such molding materials tend to be expensive, difficult to obtain in large quantities, and have a narrow range of properties, limiting customization. Additionally, the overmold may create a larger outer dimension that limits the use of such a cable within small passageways or ducts.

### SUMMARY

According to an aspect, embodiments of the disclosure relate to a cable assembly. The cable assembly includes a distribution cable containing a plurality of optical elements and having an opening formed in the distribution cable. At least one branch point is positioned along a first length of the distribution cable. The cable assembly also includes a branch cable having a bore extending along a second length thereof. Further, the cable assembly includes a thermoplastic overmold. At least one optical element of the plurality of optical elements extends from the distribution cable through the opening and into the bore of the branch cable. The thermoplastic overmold is formed around the opening of the distribution cable, an end of the branch cable, and at least a portion of the at least one optical element. The thermoplastic overmold includes maximum cross-sectional dimensions perpendicular to the first length of the distribution cable such that the cable assembly fits within a 1.25 inch duct.

According to another aspect, embodiments of the disclosure relate to a cable assembly. The cable assembly includes a distribution cable containing a plurality of optical elements and having an opening formed in the distribution cable. The cable assembly also includes a branch cable having a bore extending along a length thereof. The branch cable includes at least one tether. Further, the cable assembly includes a thermoplastic overmold. At least one optical element of the plurality of optical elements extends from the distribution cable through the opening and into the bore of the branch cable. The thermoplastic overmold is formed around the opening of the distribution cable, an end of the branch cable, and at least a portion of the at least one optical element. A bonding force between the thermoplastic overmold, an outer surface of the distribution cable, and an outer surface of the branch cable is greater than 100 lbf.

According to a further aspect, embodiments of the disclosure relate to a method of forming an overmold around a distribution cable and a branch cable in which a first optical element extends from the distribution cable into the branch cable. In the method, a distribution cable is positioned within a mold such that the distribution cable is supported by a structure within the mold. The distribution cable contains a plurality of optical elements, including the first optical element, and the distribution cable has an opening formed therein through which the first optical element extends. The opening is within the mold. A branch cable is positioned within the mold. A thermoplastic material is injected into the mold to form the overmold around the opening of the distribution cable, an end of the branch cable, and at least a portion of the first optical element.

Additional features and advantages will be set forth in the detailed description that follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding and are incorporated in and constitute a part of this specification. The drawings illustrate one or more embodiment(s), and together with the description serve to explain principles and the operation of the various embodiments.

### BRIEF DESCRIPTION OF THE DRAWINGS

FIG. 1 depicts an overmold formed around a main distribution cable and a branch cable, according to an exemplary embodiment.

FIG. 2 depicts a longitudinal cross-sectional view of the overmold around the main distribution cable and the branch cable of FIG. 1, according to exemplary embodiments.

FIGS. 3A-3C depict transverse cross-sectional views of a first side of the distribution cable, a second side of the distribution cable, and the branch cable of FIG. 1, according to an exemplary embodiment.

FIG. 4 depicts a side view of an insert used for positioning cable components during an overmolding process, according to an exemplary embodiment.

FIG. 5 depicts a perspective view of the insert of FIG. 4, according to an exemplary embodiment.

FIG. 6 depicts an overmold cable assembly, according to an exemplary embodiment.

FIG. 7 depicts an overmold of a branch cable in which a splice-protecting tube transitions to a tether, according to an exemplary embodiment.

FIG. 8 is a flow diagram of a first method for forming an overmold around a distribution cable and a branch cable, according to an exemplary embodiment.

FIG. 9 is a flow diagram of a second method for forming an overmold around a splice-protecting tube and a tether, according to an exemplary embodiment.

FIG. 10 depicts an overmold cable assembly, according to another exemplary embodiment.

FIGS. 11A-B depict a side view of the overmold around the main distribution cable and the branch cable, and a transverse cross-sectional view of the overmold around the main distribution cable and the branch cable of FIG. 10, according to an exemplary embodiment.

FIGS. 12A-B depict a side view of an overmold around a main distribution cable and a branch cable, and a transverse cross-sectional view of the overmold around the main distribution cable and the branch cable, according to another exemplary embodiment.

FIG. 13 is a flow diagram of a third method for forming an overmold around a distribution cable and a branch cable, according to another exemplary embodiment.

### DETAILED DESCRIPTION

Referring generally to the figures, various embodiments of a cable assembly with an overmold composition are provided. As will be discussed more fully below, the cable assembly includes a distribution cable containing a plurality of optical elements, and at least one branch cable containing an optical element that has split from the distribution cable. According to the present disclosure, a thermoplastic overmold is formed around the location where the branch cable extends from the distribution cable to protect the distribution cable and an end of the branch cable from environmental contamination. As compared to conventional overmold materials, the thermoplastic material of the overmold described herein is less expensive, more easily sourced, and can be formed through low-pressure injection molding processes with little waste and cure time.

Additionally, the thermoplastic overmold provides an improved strength relative to the dimensions of the thermoplastic overmold. The dimensions of the thermoplastic overmold allow for use of the cable assembly within smaller passageways or ducts. Furthermore, the thermoplastic overmold discussed herein has improved environmental sustainability. In part, the reduction in size of the thermoplastic overmold reduce the carbon dioxide equivalent per branch point of the cable assembly and for the cable assembly overall. Exemplary embodiments of the cable assembly with the thermoplastic overmold that is usable within a small passageway and method of forming the same will be described in greater detail below and in relation to the figures provided herewith, and these exemplary embodiments are provided by way of illustration, and not by way of limitation.

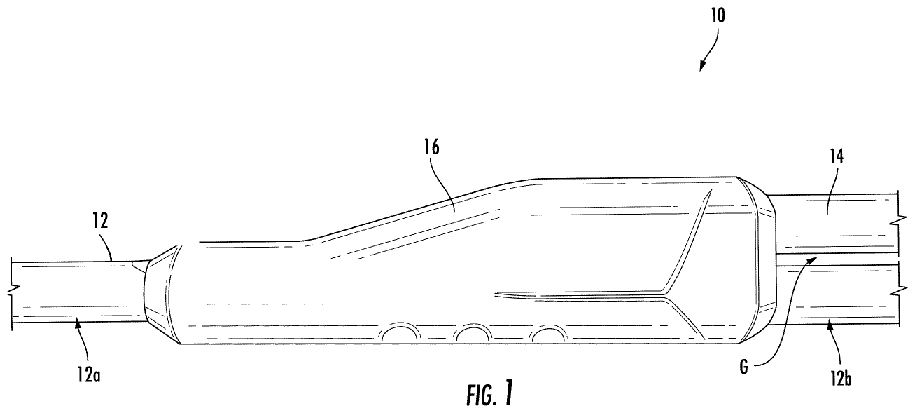

FIG. 1 depicts an embodiment of a portion of cable assembly 10. In the portion depicted, the cable assembly 10 includes a distribution cable 12 having a first side 12a and a second side 12b. The cable assembly 10 further includes a branch cable 14 extending from the distribution cable 12 between the first side 12a and the second side 12b. An overmold 16 is provided around the distribution cable 12 and the branch cable 14 at the location where the branch cable 14 extends from the distribution cable 12. Herein, the location of the overmold 16 divides the distribution cable 12 between the first side 12a (which may be considered an upstream side) and the second side 12b (which may be considered a downstream side).

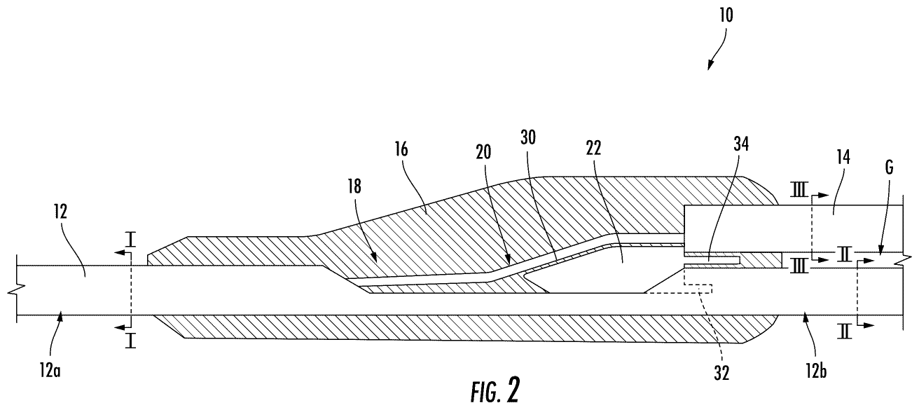

FIG. 2 depicts a cross-sectional view of the cable assembly 10 of FIG. 1 taken along the longitudinal axis of the optical assembly 10. As can be seen in FIG. 2, the distribution cable 12 includes an opening 18 through which an optical element 20 is accessed. In one or more embodiments, the optical element 20 includes at least one optical fiber. For example, the optical element 20 can be one or more optical fibers, or the optical element 20 can be an optical fiber ribbon comprising a plurality of optical fibers. At least one optical element 20 is extracted from the distribution cable 12 and directed into the branch cable 14. As will be discussed more fully below, the optical element 20 is spliced to a corresponding optical element 20 provided in the branch cable 14.

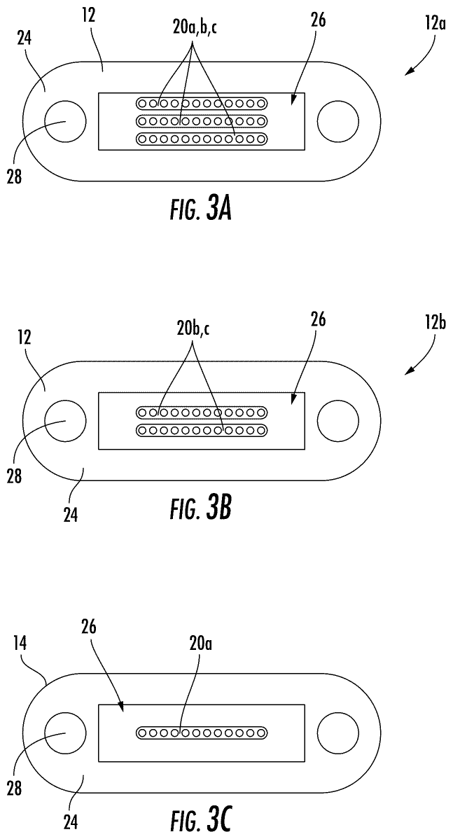

FIGS. 3A-3C depict cross-sectional views of the distribution cable 12 and the branch cable 14 showing the division of the optical elements 20 within the optical assembly 10. In FIG. 3A, the first side 12a of the distribution cable 12 includes three optical elements 20a, 20b, 20c in the form of optical fiber ribbons. The distribution cable 12 has a cable jacket 24 that includes a bore 26 extending along the longitudinal axis of the distribution cable 12. In one or more embodiments, the distribution cable 12 includes other components such as one or more strength elements 28 embedded in the cable jacket 24. In FIG. 3B, two of the optical elements 20b, 20c continue to the second side 12b of the distribution cable 12, whereas one optical element 20a is directed into the branch cable 14 as shown in FIG. 3C. In the embodiment depicted in FIGS. 3A-3C, the cable jackets 24 of the distribution cable 12 and of the branch cable 14 define a flat cable shape, but in other embodiments, the cable jacket 24 of the distribution cable 12 and the branch cable 14 may define another shape, such as a circular shape.

Returning to FIG. 2, the overmold 16 surrounds and protects the opening 18 in the distribution cable 12 and the beginning of the branch cable 14. According to embodiments of the present disclosure, the overmold 16 is formed from a thermoplastic material that can be injection molded around the distribution cable 12 and branch cable 14. In contrast to certain conventional thermosetting overmold materials, the injection molding of the molten thermoplastic material is done at relatively higher pressure and temperature. Because of this, the optical element 20 can shift out of a desired position with respect to the opening 18 and branch cable 14. Such shifting can cause the optical element 20 to bend at an undesirably sharp angle, which could cause attenuation of the optical signals carried by the optical element 20. Additionally, the branch cable 14 can shift until it abuts the distribution cable 12. However, it is desirable to maintain a gap G between the branch cable 14 and the distribution cable 12 so that the thermoplastic material of the overmold 16 fills between the branch cable 14 and the distribution cable 12 to seal the cable assembly 10 against environmental contamination, in particular water infiltration.

To prevent the optical element 20 from shifting and to maintain the gap G between the branch cable 14 and the distribution cable 12, an insert 22 is provided within the opening 18 of the distribution cable 12. As can be seen, the insert 22 provides a support for the optical element 20 to prevent the optical element from bending sharply under pressure from the molten thermoplastic material for the overmold 16. Further, the insert 22 acts as a spacer configured to maintain the gap G between the branch cable 14 and the distribution cable 12 during molding so that the molten thermoplastic material of the overmold 16 can seal between the branch cable 14 and the distribution cable 12.

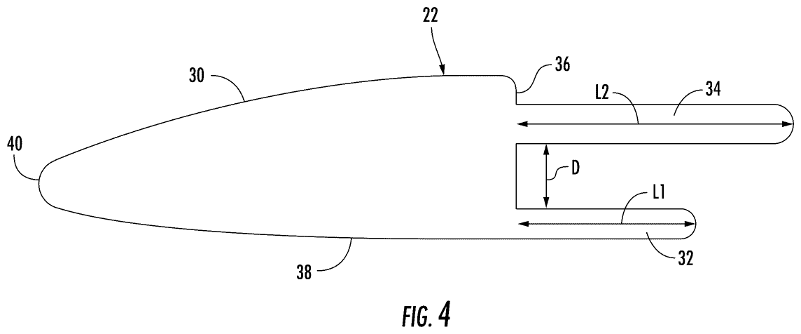

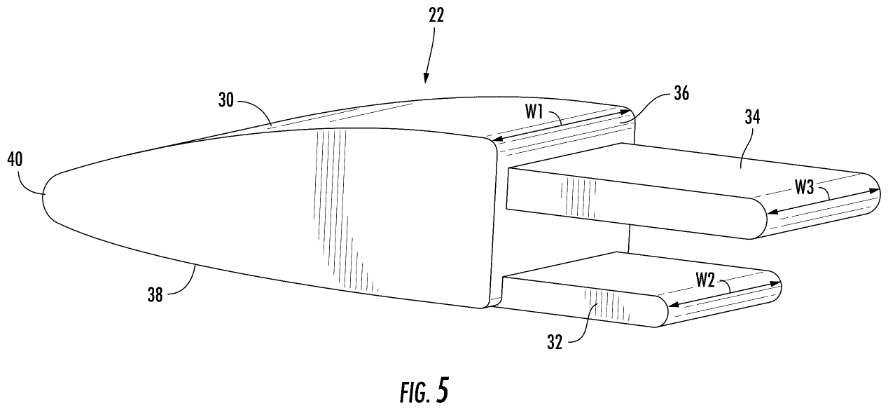

FIG. 4 depicts a side view of the insert 22. The insert 22 includes a ramp surface 30 configured to support the optical element 20 (as shown in FIG. 2). In one or more embodiments, the insert 22 includes a first tab 32 and a second tab 34. In one or more embodiments, the first tab 32 is configured to be inserted into the bore 26 of the second side 12b of distribution cable 12 (as shown in FIGS. 2 and 3B). In this way, the insert 22 is anchored into its position within the opening 18 of the distribution cable 12. In one or more embodiments, the second tab 34 is configured to maintain the gap G between the branch cable 14 and the distribution cable 12 during molding. In one or more embodiments, the second tab 34 is configured to provide a gap G of 1 mm to 2 mm between the branch cable 14 and the distribution cable 12. Thus, a distance D between the first tab 32 and the second tab 34 is selected based on the thickness of the cable jacket 24 of the distribution cable 12, and the thickness of the second tab 32 is selected to match the desired gap between the branch cable 14 and the distribution cable 12.

The first tab 32 has a first length L1, and the second tab 34 has a second length L2. In one or more embodiments, the first length L1 is equal to the second length L2. In one or more embodiments, including the embodiment shown in FIG. 4, the first length L1 is shorter than the second length L2. However, in one or more other embodiments, the first length L1 is longer than the second length L2. In one or more embodiments, the overmold 16 covers a length of the second side 12b of the distribution cable 12 and of the branch cable 14, and the second length L2 of the second tab 34 is about half the length of the cables 12, 14 covered by the overmold 16 or less.

As mentioned, the insert 22 is configured to maintain the desired position of components of the cable assembly 10 during molding, and thus, the insert 22 is positioned within the opening 18 of the distribution cable 12 prior to molding. To facilitate the molding process, the insert 22 also includes an abutment surface 36 that acts as a stop for the branch cable 14 when the branch cable 14 is inserted into the mold during molding. That is, the insert 22 also helps to ensure that the branch cable 14 is properly placed within the mold during molding so that the thermoplastic material is able to adequately seal around and bond to the end of the branch cable 14. In one or more embodiments, the abutment surface 36 is substantially perpendicular (e.g., forms an angle of 90°±10°) with the second tab 34.

As shown in FIG. 4, the first tab 32 forms a substantially continuous surface with a bottom surface 38 of the insert 22. The bottom surface 38 of the insert 22 is configured to rest at least partially against the cable jacket 24 of the distribution cable 12 in the opening 18. In the embodiment shown in FIG. 4, the bottom surface 38 curves upwardly toward the ramp surface 30, and the bottom surface 38 transitions into the ramp surface 30 at curved end 40 of the insert 22. The insert 22 includes curved surfaces 30, 38 and end 40 to prevent sharp steps, which could create optical attenuation losses on the optical signals passing through the optical element 20.

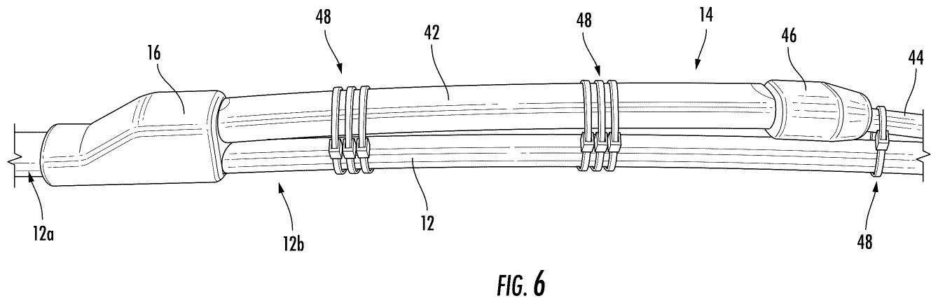

FIG. 5 depicts a perspective view of the insert 22. As can be seen, the ramp surface 30, the abutment surface 36, and the bottom surface 38 define a first width W1 of the insert 22. As mentioned, the first width W1 may be selected to allow the insert 22 to rest against the cable jacket 24 outside of the bore 26. In this regard, the first width W1 may be dependent upon the size of the distribution cable 12 in that a wider insert 22 may be used with a wider distribution cable 12. In one or more embodiments, the first width W1 is wider than the width of the bore 26 of the distribution cable 12 but no wider than the width of the distribution cable 12. The first tab 32 has a second width W2. In one or more embodiments, the second width W2 of the first tab 32 is selected to allow the first tab 32 to be inserted into the bore 26 of the second side 12b of the distribution cable 12. Thus, in one or more embodiments, the second width W2 is less than the first width W1. The second tab 34 has a third width W3. In one or more embodiments, the third width W3 is equal to or greater than the second width W2; however in one or more other embodiments, the third width W3 can instead be less than the second width W2. In an example embodiment, two branch cables 14 extend from the overmold 16, and the third width W3 of the second tab 34 may be greater than the second width W2 of the first tab 32 to provide sufficient support to maintain the gap G between the distribution cable 12 and the two branch cables 14.

In order to position the insert 22 within the opening 18, the shape of the first tab 32 can be changed to match the shape of the bore 26. As shown in FIG. 3B, the distribution cable 12 has a rectangular bore 26, and the first tab 32 may have a flat surface and sides to engage the bore 26 (e.g., as shown in FIG. 5). In one or more other embodiments, the distribution cable 12 may have a circular bore 26, and the first tab 32 may have a convexly curved upper surface to engage the bore 26.

In one or more embodiments, the insert 22 is molded from a polymer material. The polymer material may be any of a variety of materials capable of withstanding the molding temperature and pressures. In particular, the insert 22 should not melt, soften, or deform when exposed to the molten thermoplastic material of the overmold 16.

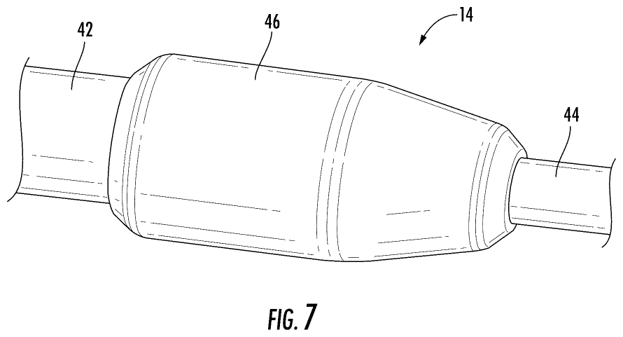

FIG. 6 depicts a wider view of the cable assembly 10. The cable assembly 10 includes the distribution cable 12, the branch cable 14, and the overmold 16 at the location where the branch cable 14 extends from the distribution cable 12. In one or more embodiments, the branch cable 14 includes a splice-protecting tube 42 that transitions to a tether 44. In one or more embodiments, the transition between the tube 42 and tether 44 is covered by a second overmold 46. In the cable assembly 10, the tether 44 includes an optical element 20 configured to communicate with an optical element 20 of the distribution cable 12. That is, a length of an optical element 20 is pulled from the distribution cable 12 at the opening 18 and spliced to the optical element 20 of the tether 44.

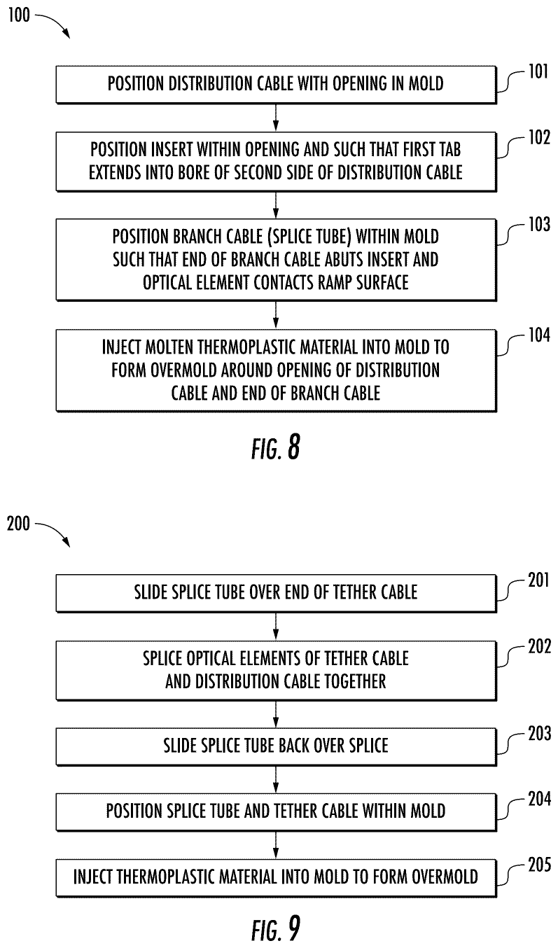

As shown in FIG. 7, the tube 42 has a first width, and the tether 44 has a second width. In one or more embodiments, the first width is different, in particular greater, than the second width. In this way, the tube 42 can be slid over the end of the tether 44. During splicing, the tube 42 is slid over the end of the tether 44 such that the tether 44 is within the tube 42. Further, during splicing, the optical element 20 extending from the tether 44 is spliced to the optical element 20 of the distribution cable 12. Thereafter, the tube 42 is slid back from its temporary storage position around the tether 44 to the location over the splice between the optical elements 20 to protect the splice and the optical elements 20 in the region between the opening 18 and the end of the tether 44.

Returning to FIG. 6, the tube 42 and the tether 44 are secured to the distribution cable 12. In one or more embodiments, a plurality of binders 48, such as cable ties, are provided around the tube 42 and the distribution cable 12 between the overmold 16 and the second overmold 46 and another binder 48 is provided around the tether 44 and the distribution cable 12 downstream of the second overmold 46. By securing the tube 42 against the distribution cable 12, the splice between the optical elements 20 of the distribution cable 12 and the tether 44 is protected from being stressed, twisted, or bent in a way that could break the splice or create attenuation. While FIG. 6 depicts a single branch point for the cable assembly 10, it should be noted that the cable assembly 10 can include multiple such branch points at a single overmold and/or along the length of the distribution cable 12 as needed to direct optical signals within an optical network.

Having described the cable assembly 10, the thermoplastic material of the overmold 16 and the second overmold 46 will now be described. According to the present disclosure, the thermoplastic material is selected to have one or more of the following characteristics: low melting temperature, high melt flow rate and good processability, balance between hardness and elastic modulus, strong adherence to the cable jackets, good low temperature performance, ultraviolet and chemical resistance, and strong mechanical properties.

In one or more embodiments, the thermoplastic material of the overmold 16, 46 has a high melt flow rate. In one or more embodiments, the melt flow rate is at least 4 g/10 min at 190° C., at least 10 g/10 min at 190° C., or at least 14 g/10 min at 190° C., as measured according to ASTM D 1238—Automatically Timed Flow Rate, Procedure B (21.6 kg standard weight). The high melt flow rate improves the processability during injection molding of thermoplastic material around the distribution cable 12. In particular, the high melt flow rate improves the flow of the molten thermoplastic material around the distribution cable 12 and the branch cable 14 within the injection molding apparatus.

Further, in one or more embodiments, the thermoplastic material of the overmold 16, 46 balances hardness and elastic modulus such that the thermoplastic material withstands deformation and external mechanical loads but is sufficiently flexible to support the branched cable assemblies from experiencing kinking. In one or more embodiments, the thermoplastic material has a hardness in the range of 60 to 95, in particular in the range of 85 to 88, as measured according to ASTM D2240-15 (Shore A, Instantaneous). Further, in one or more embodiments, the thermoplastic material has an elastic modulus in the range of 70 MPa to 250 MPa, in particular in the range of 100 MPa to 150 MPa, as measured according to ASTM D638-14.

Additionally, in one or more embodiments, the thermoplastic material is designed to adhere strongly to the cable jackets 24 of the distribution cable 12 and the branch cable 14. In this way, the overmold 16, 46 provides a strong seal against environmental contamination, especially water infiltration.

Still further, in one or more embodiments, the thermoplastic material of the overmold 16, 46 should be able to pass relevant cable standards such as Telcordia Generic Requirements, including GR-20-CORE and GR-3122-CORE. The GR-20-CORE requirements relate to outside plant cables and require good impact strength and crack resistance at low temperatures as well as UV and chemical resistance. The GR-3122-CORE standard relates to factory-installed termination systems and provides information regarding the ability of an overmold material to withstand conditions that can severely damage bonding between the cable jackets and the overmold material as heat and moisture cause material deformation and degradation which affect the bonding.

In one or more embodiments, the overmold 16, 46 is formed from a thermoplastic material including a polyolefin component and a thermoplastic polyolefin elastomer component. In one or more embodiments, the thermoplastic material of the overmold 16, 46 comprises the polyolefin component in an amount in a range of 30 wt % to 80 wt %. In one or more embodiments, the polyolefin component is selected from a group consisting of low-density polyethylene, medium-density polyethylene, high-density polyethylene, linear low-density polyethylene, and combinations thereof. In one or more embodiments, the thermoplastic material of the overmold 16, 46 comprises the thermoplastic polyolefin elastomer component in an amount in a range of 20 wt % to 70 wt %. In one or more embodiments, the thermoplastic polyolefin elastomer component is selected from a group consisting of an olefin block copolymer (e.g., INFUSE®), olefin random copolymer (e.g., Engage™), ethylene-propylene rubber (EPR), ethylene-propylene-diene rubber (EPDM), ethylene-octene (EO), ethylene-hexene (EH), ethylene-butene (EB), ethylene-vinyl acetate (EVA), ethylene acrylic acid (EAA), ethylene-butyl acetate (EBA), styrene-ethylene-butadiene-styrene (SEBS), and combinations of any two or more thereof.

In one or more embodiments, the thermoplastic material of the overmold 16, 46 includes up to 10 wt % of other processing and/or performance aids, including up to 3 wt % of carbon black, up to 1 wt % of a UV stabilizer (e.g., hindered amine light stabilizers), up to 3 wt % of an antifungal additive, and up to 3 wt % of other additives, such as color pigments, processing aids, or a functional filler.

A thermoplastic material according to the foregoing composition provides several advantages when used as an overmold 16, 46 of a cable assembly 10. In particular, the thermoplastic material has a low melting temperature, which is less than 200° C. and more particularly less than 150° C. Further, the thermoplastic material has low melt viscosity (or high melt flow rate) and good processability, making it suitable for low pressure (e.g., 250 psi or less) injection molding. The thermoplastic material is also particularly suitable for adhesion to typical polyethylene-based cable jacket materials. Still further, the thermoplastic material is suitable for use in low temperature conditions, having a glass transition temperature of −35° C. or less. Additionally, it is expected that the thermoplastic material is suitable for use not only at temperatures as low as −40° C. but also up to 95° C., and the thermoplastic material has good UV and chemical resistance. Also advantageously, the thermoplastic composition has a lower material cost than conventional polyurethane-based, thermosetting overmold compositions.

According to a first example embodiment, the thermoplastic material of the overmold 16, 46 includes 69 wt % LDPE (Agility™ 722, available from The Dow Chemical Company, Midland, MI), 24 wt % TPE (Infuse™ 9807, available from The Dow Chemical Company, Midland, MI), 6 wt % of an LDPE-based carbon black masterbatch (DFNA-0037BK, which includes 50 wt % loading of carbon black in Agility™ 722, available from The Dow Chemical Company, Midland, MI), and 1 wt % of zinc pyrithione (Zinc Omadine®, which includes 20 wt % loading of zinc pyrithione (ZnPT or bis(2-pyridylthio) zinc 1,1′-dioxide) in Agility™ 722).

The example thermoplastic material for the overmold 16, 46 had a density in the range of 0.91 to 0.92 g/cm³, a tensile stress at break in the range of 8 MPa to 10 MPa (in particular 8 MPa to 9 MPa), a tensile strain at break in the range of 500 to 600% (in particular 520% to 540%), a toughness in the range of 30 to 50 MPa, a melt flow rate in the range of 9.8 to 10.5 g/10 min at 190° C., and a Shore A hardness (instantaneous) in the range of 85 to 88. Additionally, it was determined that the peak melting temperature of the thermoplastic material of the overmold 16, 46 was in the range of 95° C. to 115° C.

According to another embodiment, the thermoplastic material of the overmold 16 is a polyethylene-based hot melt adhesive. A commercially available example of such a polyethylene-based hot melt adhesive is Technomelt® AS produced by Henkel Corporation (Dusseldorf, Germany). In one or more embodiments, the hot melt adhesive includes a low-molecular weight polyethylene and hydrotreated heavy naphthenic materials. Further, in one or more embodiments, the polyethylene-based hot melt adhesive may include various additives, such as carbon black, antifungal additives, fillers, viscosity modifiers, among others.

FIG. 8 provides a flow diagram of a method 100 for forming one or more overmolds 16 according to the present disclosure. In a first step 101 of the method 100, the distribution cable 12 is positioned within a mold. In particular, the opening 18 of the distribution cable 12 is positioned within a cavity of a mold for forming the overmold 16. In a second step 102 of the method 100, the insert 22 is positioned within the opening 18 of the distribution cable 12 such that the first tab 32 extends into the bore 26 of the second side 12b of the distribution cable 12. As mentioned above, this anchors the insert 22 into position within the mold. In a third step 103 of the method 100, the branch cable 14 is positioned within the mold such that the branch cable 14 abuts the insert 22 and the optical element 20 contacts the ramp surface 30. As described above, the branch cable 14 may abut the insert 22 in at least one of two ways, including against the second tab 34 (thereby providing the desired gap G for overmold 16 sealing) and against the abutment surface 36 (thereby ensuring that the overmold 16 surrounds a sufficient portion of the end of the branch cable 14). Further, as described above, the particular component of the branch cable 14 inserted into the mold may be a tube 42. In a fourth step 104, the thermoplastic material as described herein is injected into the mold to surround the opening 18 of the distribution cable 12 and the end of the branch cable 14, thereby forming the overmold 16.

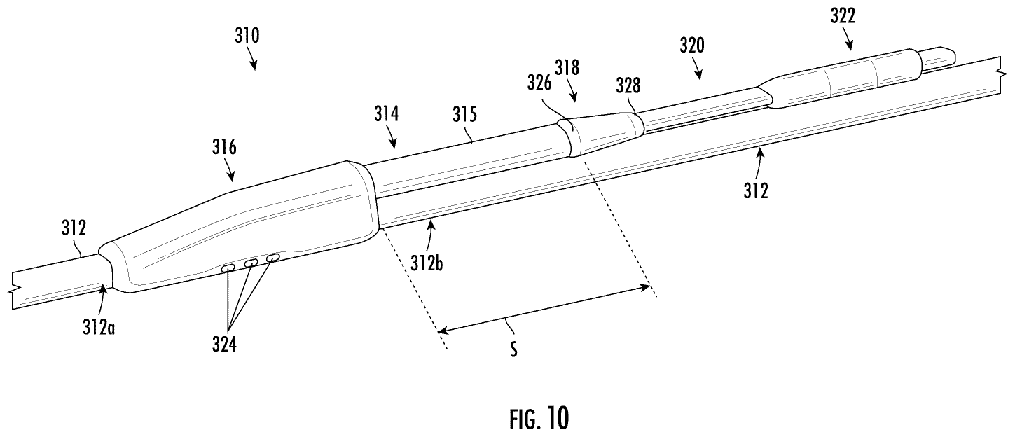

FIG. 9 provides a flow diagram of a second method 200 of forming the second overmold 46 around the tube 42 and tether 44 using the thermoplastic material as described herein. In a first step 201 of the method 200, a tube 42 is slid over an end of the tether 44. In a second step 202 of the method 200, an optical element 20 of the tether 44 is spliced to an optical element 20 of a distribution cable 12, e.g., using (mass) fusion splicing. In a third step 203 of the method 200, the tube 42 is slid back over the splice between the optical elements 20 of the distribution cable 12 and the tether 44. In one or more embodiments, the tube 42 may remain at least partially overlapped with the tether 44 such that a portion of the tether 44 remains within the tube 42. In a fourth step 204 of the method 200, the tube 42 and tether 44 are positioned within a mold, and in a fifth step 205 of the method 200, the thermoplastic material described herein is injected into the mold to form the second overmold 46 around the ends of the tube 42 and the tether 44. In embodiments in which the branch cable 14 includes a tube 42 and tether 44, the second method 200 to form the second overmold 46 may be performed prior to performing the first method 100 to form the overmold 16 around the opening 18 of the distribution cable 12 and end of the branch cable 14.

The thermoplastic material of the overmold 16, 46 provides many advantages over conventional thermosetting overmold materials, such as polyurethane. Such conventional overmold materials are comparatively more expensive and difficult to source than the disclosed thermoplastic material. Additionally, conventional overmold materials have a short pot life, leading to waste, and have a slow rate of cure, decreasing throughput. In contrast, the disclosed thermoplastic material for the overmold 16, 46 is widely available, easily sourced, and less expensive while also meeting all requirements for cable durability and environmental resistance. Further, when the insert 22 described above is used, the thermoplastic material can be low-pressure injection molded to form the overmold 16 around the distribution cable 12 and branch cable 14, sealing the distribution cable 12 and branch cable 14 against environmental contamination, without creating sharp bends in the optical element 20.

FIG. 10 depicts an embodiment of a portion of cable assembly 310. In the portion depicted, the cable assembly 310 includes a distribution cable 312 having a first side 312a and a second side 312b. The cable assembly 310 further includes a branch cable 314 extending from the distribution cable 312 between the first side 312a and the second side 312b. An overmold 316 is provided around the distribution cable 312 and the branch cable 314 at the location where the branch cable 314 extends from the distribution cable 312. Herein, the location of the overmold 316 divides the distribution cable 312 between the first side 312a (upstream side) and the second side 312b (downstream side).

As discussed above the overmold 316 surrounds and protects an opening (see e.g., 18 in FIG. 2) in the distribution cable 312 and the beginning of the branch cable 314. According to embodiments of the present disclosure, the overmold 316 can be formed from a thermoplastic material molded around the distribution cable 312, the branch cable 314, and an insert (see e.g., 22 in FIG. 2). In other embodiments, the overmold 316 is molded around the distribution cable 312 and the branch cable 314. As will be discussed in greater detail below, in various embodiments, overmold 316 includes one or more recessed sections 324.

In one or more embodiments, the branch cable 314 includes a tube 315 that transitions to a tether 320. As will be generally understood, tubing is used in fiber optic networks to transition multi-fiber optical cables into a reduced number or optical fibers and/or individual optical fibers. In one or more embodiments, the transition between the tube 315 and tether 320 is covered by a second overmold 318. In other words, tube 315 is a first end of branch cable 314 and includes a second end, distal from the first end. Second overmold 318 is formed around the second end of tube 315 and a third end of tether 320. In one or more embodiments, second overmold 318 includes a first chamfer 326 and a second chamfer 328. First chamfer 326 is positioned on an end of second overmold 318 adjacent to tube 315 while second chamfer 328 is positioned on an end of second overmold 318 adjacent to tether 320. First and second chamfers 326, 328 prevent snagging of overmold 318 during installation of the cable assembly. In other words, the chamfered shape of second overmold 318 allows second overmold to more easily slide over structures such as the edge of a duct as the cable assembly is pulled through a duct.

In the cable assembly 310, the tether 320 includes an optical element (see e.g., 20 in FIG. 2) configured to communicate with an optical element of the distribution cable 312. That is, a length of an optical element is pulled from the distribution cable 312 at the opening and spliced to the optical element of the tether 320. Tube 315, specifically a cavity within tube 315, covers the splice and/or a splice protector.

In one or more embodiments, tether 320 is a drop cable. In such an embodiment, tether 320 is coupled to a connector 322. Specifically, tether 320 includes a fourth end distal from the third end with connector 322 coupled to the fourth end of tether 320 and the optical element of tether 320. Examples of commercially available connectors suitable for use as the connector 322 include a Puslok™ Connector manufactured by Corning Incorporated. While FIG. 10 depicts a single branch point for the cable assembly 310, it should be noted that the cable assembly 310 can include multiple such branch points at a single overmold 316 and/or along the length of the distribution cable 312 as needed to direct optical signals within an optical network.

As shown in FIG. 10, the first overmold 316 is separated from the second overmold 318 by a space S. That is, the first overmold 316 and the second overmold 318 are separate structures and do not form one continuous structure surrounding the entire tube 315. In one or more embodiments, the tube 315 has a length of about 30 cm, and the first overmold 316 covers about 10 mm to 15 mm of the first end, and the second overmold covers about 10 mm to 15 mm of the second end. Thus, most of the length of the tube 315 is not covered by the thermoplastic material of the overmolds 316, 318. In one or more embodiments, the space S between the first overmold 316 and the second overmold 318 is from 12 cm to 28 cm, in particular from 20 cm to 26 cm. Advantageously, in contrast to certain conventional thermosetting overmold materials that covered the entire length of the tube 315, the use of two different overmolds 316, 318 with a space S therebetween requires the use of less material and simpler, smaller molds.

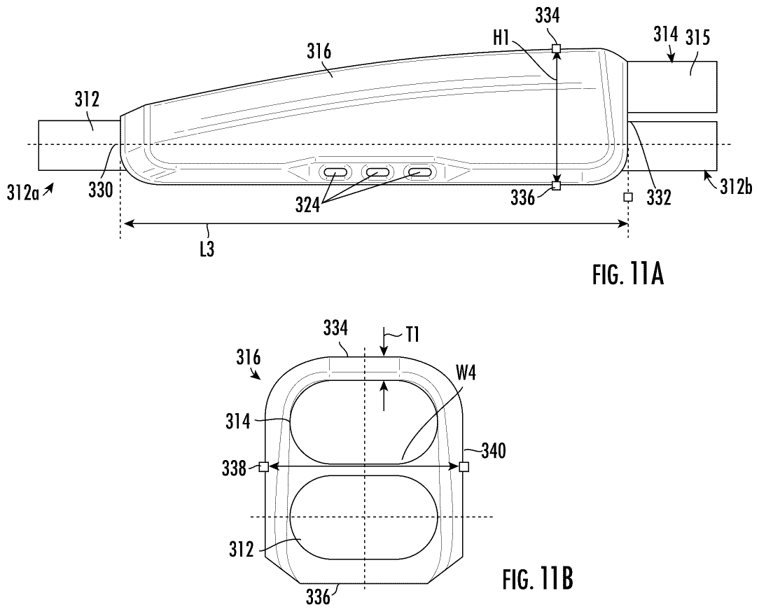

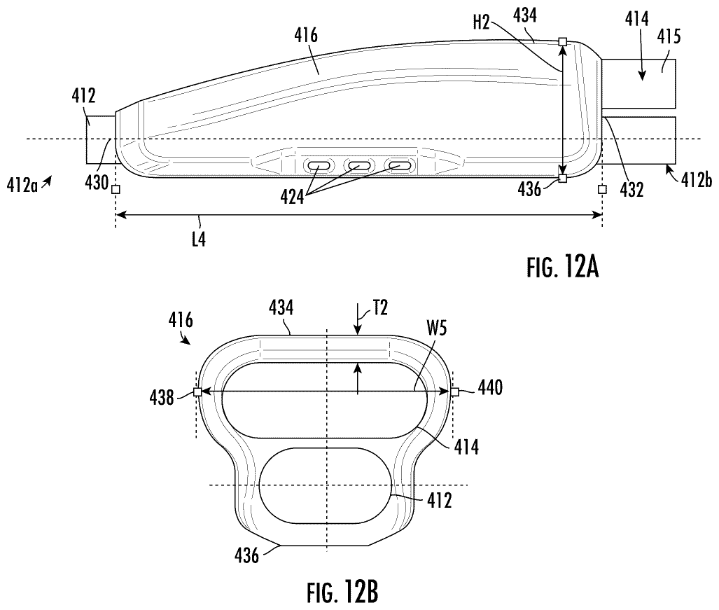

FIGS. 11A-B depict a side view of the overmold 316 around distribution cable 312 and the branch cable 314, and a transverse cross-sectional view of the overmold 316 around the distribution cable 312 and the branch cable 314. As noted above, overmold 316 is sized to allow for use in narrow passageways or ducts. Specifically, in one or more embodiments, overmold 316 has maximum cross-sectional dimensions perpendicular to a length of the distribution cable 312 such that the cable assembly 310 fits within a 1.25 inch duct.

In FIG. 11A, a side view of a single tether configuration is shown according to an exemplary embodiment. Overmold 316 includes a proximal end 330 at the first side 312a of distribution cable 312 and a distal end 332 at the second side 312b of distribution cable 312. A third length, L3, of overmold 316 is defined between the proximal end 330 and the distal end 332. In one or more embodiments, third length L3 is 100 mm or less, 95 mm or less, or more preferably 90 mm or less. In one or more embodiments, third length L3 is at least 50 mm. In an embodiment, third length L3 is about 85 mm plus or minus 1 mm.

In one or more embodiments, a first maximum cross-sectional dimension of the overmold 316, a first height, H1, is defined between an upper surface 334 and a lower surface 336 of overmold 316. In one or more embodiments, the first height H1 is 28 mm or less, 26 mm or less, or more preferably 24 mm or less. In one or more embodiments, first height H1 is at least 20 mm. In an embodiment, the first height H1 is about 23 mm plus or minus 1 mm. As shown in FIG. 11B, a second maximum cross-sectional dimension of the overmold 316 is perpendicular to the first maximum cross-sectional dimension or the first height H1. The second maximum cross-sectional dimension, fourth width W4, is defined between a first side surface 338 and a second side surface 340 of overmold 316. In a specific embodiment, the fourth width W4 is defined at the widest point of overmold 316. In one or more embodiments, the fourth width W4 is 25 mm or less, 23 mm or less, or more preferably 21 mm or less. In one or more embodiments, the fourth width W4 is at least 15 mm. In an embodiment, the fourth width W4 is about 20.3 mm plus or minus 1 mm.

In one or more embodiments, the overmold 316 has a first thickness T1 that is a maximum thickness of the overmold 316. As shown in FIG. 11B, the first thickness T1 is shown as a portion of the overmold 316 disposed over the branch cable 314, but the maximum thickness may be located in a different location of the overmold 316 with respect to the distribution cable 312 or the branch cable 314. In one or more embodiments, the first thickness T1 is 5 mm or less, in particular 4 mm or less. In one or more embodiments, the first thickness T1 is in a range from 1 mm to 3 mm, in particular in a range from 2 mm to 3 mm.

FIGS. 12A-B depict a side view of an overmold 416 around distribution cable 412 and the branch cable 414, and a transverse cross-sectional view of the overmold 416 around the distribution cable 412 and the branch cable 414. Overmold 416 is substantially the same as overmold 316 except for the difference discussed herein. While overmold 316 is configured for a single tether, overmold 416 is configured for more than one tether. In a specific embodiment, overmold 416 is sized to allow for two tethers. The cable assembly including more than one tether can similarly use additional overmolds like the second overmold 318 at additional transition points. Overmold 416 is further sized to allow for use in narrow passageways or ducts. Specifically, overmold 416 has an outer dimension such that the cable assembly fits within a 1.25 inch duct.

In FIG. 12A, a side view of a dual tether configuration is shown according to an exemplary embodiment. Overmold 416 includes a proximal end 430 at the first side 412a of distribution cable 412 and a distal end 432 at the second side 412b of distribution cable 412. A fourth length L4 of overmold 416 is defined between the proximal end 430 and the distal end 432. In one or more embodiments, the fourth length L4 is 100 mm or less, 95 mm or less, or more preferably 90 mm or less. In one or more embodiments, the fourth length L4 is at least 50 mm. In an embodiment, the fourth length L4 is about 83 mm plus or minus 2 mm.

In one or more embodiments, a first maximum cross-sectional dimension of the overmold 416, a second height H2 is defined between an upper surface 434 and a lower surface 436 of overmold 416. In one or more embodiments, the second height H2 is 28 mm or less, 26 mm or less, or more preferably 25 mm or less. In one or more embodiments, the second height H2 is at least 20 mm. In an embodiment, the second height H2 is about 23.6 mm plus or minus 1 mm. As shown in FIG. 12B, a second maximum cross-sectional dimension of the overmold 416 is perpendicular to the first maximum cross-sectional dimension or H2. The second maximum cross-sectional dimension, fifth width W5, is defined between a first side surface 438 and a second side surface 440 of overmold 416. In a specific embodiment, the fifth width W5 is defined at the widest point of overmold 416. In one or more embodiments, the fifth width W5 is 31 mm or less, or more preferably 30 mm or less. In one or more embodiments, the fifth width W5 is at least 25 mm. In an embodiment, fifth width W5 is about 29 mm plus or minus 1 mm.

In one or more embodiments, the overmold 416 has a second thickness T2 that is a maximum thickness of the overmold 416. As shown in FIG. 12B, the second thickness T2 is shown as a portion of the overmold 416 disposed over the branch cables 414, but the maximum thickness may be located in a different location of the overmold 416 with respect to the distribution cable 412 or the branch cables 414. In one or more embodiments, the second thickness T2 is 5 mm or less, in particular 4 mm or less. In one or more embodiments, the second thickness T2 is in a range from 1 mm to 3 mm, in particular in a range from 2 mm to 3 mm.

Additionally, as noted above the thermoplastic overmold material is designed to adhere strongly to the distribution cables 312, 412 and the branch cables 314, 414. The overmolds discussed herein include improved strength relative their size which allows for use of the cable assembly in small passageways or ducts including 1.25 inch ducts. The adhesion of the overmold material to the distribution cable and branch cables can be demonstrated by a pull test in which one end of a distribution cable is anchored, and a load frame pulls against the overmold until the distribution cable fails. Using such a pull test, the bonding force between the overmold and the distribution and branch cables can be determined. The pull test can be performed using a load frame. Specifically, one end of the distribution cable is secured to a fixture, and a pulling member is secured below the overmold. When the pulling member is moved away from the fixture, stress is applied to the overmold to attempt to strip the overmold from the distribution cable and the branch cable. Applicant has found that previous overmolds typically held between 50-75 lbf before failure.

In one or more embodiments, the bonding force between the overmold 316, 416 the distribution cable 312, 412, and the branch cable 314, 414 is at least 100 lbf as measured using the pull test described above. In one or more embodiments, the bonding force is at least 200 lbf, at least 250 lbf, at least 300 lbf, at least 350 lbf, or at least 400 lbf. In one or more embodiments, the bonding force is up to 500 lbf.

A similar pull test can be performed on second overmold 318. A bonding force between second overmold 318 the tube 315, and the tether 320 is at least 100 lbf. In one or more embodiments the bonding force for the second overmold 318 is at least 150 lbf, at least 200 lbf, or at least 250 lbf. In one or more embodiments, the bonding force is up to 300 lbf.

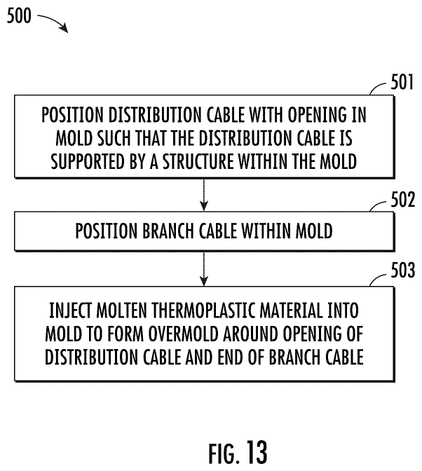

FIG. 13 provides a flow diagram of a method 500 for forming one or more overmolds 316, 416 according to the present disclosure. In a first step 501 of the method 500, the distribution cable 312, 412 is positioned within a mold. In particular, the opening of the distribution cable 312, 412 is positioned within a cavity of a mold for forming the overmold 316, 416. Distribution cable 312, 412 is supported by a structure positioned within the mold. In one or more embodiments, the support structure is one or more protrusions of the mold. By providing such support, recessed sections 324, 424 may be formed on overmold 316.

In a second step 502 of the method 500, the branch cable 314 (or tube 415 for multiple branch cables 414) is positioned within the mold. In one or more embodiments, an insert 22 as described above in relation to FIGS. 1-5 is provided in the opening of the distribution cable 312, 412, and the branch cable 314 (or tube 415 for multiple branch cables 414) is inserted into the mold such that the branch cable 314 (or tube 415 for multiple branch cables 414) abuts the insert. Further, as described above, the particular component of the branch cable 314, 414 inserted into the mold may be a tube 315, 415.

In a third step 503, the thermoplastic material as described herein is injected into the mold to surround the opening of the distribution cable 312, 412 and the end of the branch cable 314 (or tube 415 for multiple branch cables 414), thereby forming the overmold 316, 416. In one or more embodiments, the thermoplastic material is injection molded at a temperature in a range from 200° C. to 220° C., which Applicant has found provides good bonding to the cable jacket of the distribution cable (in particular when the cable jacket is a polyethylene material). Advantageously, no surface preparation steps are required to achieve the good bonding between the thermoplastic overmold material and the cable jacket of the distribution cable. In contrast, certain conventional overmold materials required that the cable jacket undergo surface processing steps to provide acceptable bonding between the thermosetting overmold material and the thermoplastic cable jacket material. Further, as mentioned, the support structure in the mold may assist in preventing the distribution cable 312, 412 from bowing under the pressures associated with injecting the thermoplastic material in the third step 503.

As described above, in one or more embodiments, method 500 can further include forming a splice between a second optical element of the tether 320 and the first optical element of the distribution cable 312. The tube 315 and tether 320 can be placed in a second mold before the thermoplastic material as described herein is injected into the second mold to form a second overmold around the respective ends of the tube 315 and tether 320. In one or more embodiments, prior to positioning the distribution cable within the second mold, a connector 322 is coupled to the second optical element of tether 320 at a distal end of tether 320. In one or more embodiments, method 500 includes positioning an insert within the distribution cable 312 as previously described in method 100 above.

As discussed above, Applicant believes the thermoplastic overmold discussed herein has improved environmental sustainability. In part, the reduction in dimensions of the thermoplastic overmold reduces the carbon dioxide equivalent per branch point of the cable assembly and for the cable assembly overall. For example, Applicant believes use of the thermoplastic overmold discussed herein reduces the CO₂ equivalent from 1.82 kg CO₂e/branch point to 0.14 82 kg CO₂e/branch point.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A cable assembly, comprising:
a distribution cable containing a plurality of optical elements and having an opening formed in the distribution cable, at least one branch point is positioned along a first length of the distribution cable;
a branch cable having a bore extending along a second length thereof, and
a thermoplastic overmold;
wherein at least one optical element of the plurality of optical elements extends from the distribution cable through the opening and into the bore of the branch cable;
wherein the thermoplastic overmold is formed around the opening of the distribution cable, an end of the branch cable, and at least a portion of the at least one optical element; and
wherein the thermoplastic overmold comprises maximum cross-sectional dimensions perpendicular to the first length of the distribution cable such that the cable assembly fits within a 1.25 inch duct.

2. The cable assembly of claim 1, wherein a first maximum cross-sectional dimension of the thermoplastic overmold is 26 mm or less.

3. The cable assembly of claim 2, wherein a second maximum cross-sectional dimension of the thermoplastic overmold perpendicular to the first maximum cross-sectional dimension is 23 mm or less.

4. The cable assembly of claim 1, wherein the thermoplastic overmold includes a proximal end and a distal end and wherein a third length of the thermoplastic overmold is defined between the proximal end and the distal end, the third length of the thermoplastic overmold being 100 mm or less.

5. The cable assembly of claim 1, wherein a bonding force between the thermoplastic overmold, the distribution cable, and the branch cable is 100 lbf or greater.

6. The cable assembly of claim 5, wherein the bonding force between the thermoplastic overmold, the distribution cable, and the branch cable is from 100 lbf to 500 lbf.

7. The cable assembly of claim 1, wherein the branch cable comprises a tube and a tether, the tether comprising a second optical element, wherein the at least one optical element is joined to the second optical element at a splice, wherein the tube covers the splice.

8. The cable assembly of claim 7, wherein the tube comprises a first end of the branch cable and a second end distal from the first end, wherein the tether comprises a third end, and wherein a second thermoplastic overmold is formed around the second end of the tube and the third end of the tether.

9. The cable assembly of claim 8, wherein the branch cable further comprises a connector and the tether further comprises a fourth end distal from the third end, and wherein the connector couples to the second optical element of the tether on the fourth end of the tether.

10. The cable assembly of claim 8, wherein a bonding force between the second thermoplastic overmold, the tube, and the tether is 100 lbf or greater.

11. The cable assembly of claim 7, wherein the branch cable comprises a second tether, the second tether comprising a third optical element, wherein the at least one optical element is joined to the third optical element at a second splice.

12. The cable assembly of claim 1, further comprising an insert positioned within the opening of the distribution cable such that the end of the branch cable abuts the insert and such that the at least one optical element is supported by a surface of the insert.

13. An optical fiber cable assembly, comprising:
a distribution cable containing a plurality of optical elements and having an opening formed in the distribution cable;
a branch cable having a bore extending along a length thereof, the branch cable comprising at least one tether; and
a thermoplastic overmold;
wherein at least one optical element of the plurality of optical elements extends from the distribution cable through the opening and into the bore of the branch cable;
wherein the thermoplastic overmold is formed around the opening of the distribution cable, an end of the branch cable, and at least a portion of the at least one optical element; and
wherein a bonding force between the thermoplastic overmold, an outer surface of the distribution cable, and an outer surface of the branch cable is greater than 100 lbf.

14. The optical fiber cable assembly of claim 13, wherein the at least one tether comprises a first tether and a second tether.

15. The optical fiber cable assembly of claim 14, wherein the thermoplastic overmold comprises maximum outer cross-sectional dimensions such that the optical fiber cable assembly fits within a 1.25 inch duct.

16. The optical fiber cable assembly of claim 15, wherein a first maximum cross-sectional dimension of the thermoplastic overmold is 26 mm or less.

17. The optical fiber cable assembly of claim 16, wherein a second maximum cross-sectional dimension of the thermoplastic overmold perpendicular to the first maximum cross-sectional dimension is 31 mm or less.

18. The optical fiber cable assembly of claim 14, wherein the bonding force between the thermoplastic overmold, the outer surface of the distribution cable, and the outer surface of the branch cable is from 100 lbf to 500 lbf.

19. The optical fiber cable assembly of claim 13, wherein the at least one tether comprises a second optical element, wherein the at least one optical element is joined to the second optical element at a splice, wherein a tube covers the splice.

20. A method of forming an overmold around a distribution cable and a branch cable in which a first optical element extends from the distribution cable into the branch cable, comprising:
positioning a distribution cable within a mold such that the distribution cable is supported by a structure within the mold, the distribution cable containing a plurality of optical elements, including the first optical element, and the distribution cable having an opening formed therein through which the first optical element extends, the opening being within the mold;
positioning a branch cable within the mold; and
injecting a thermoplastic material into the mold to form the overmold around the opening of the distribution cable, an end of the branch cable, and at least a portion of the first optical element.

21. The method of claim 20, wherein the branch cable comprises a tube and a tether and wherein, prior to positioning the distribution cable within the mold, the method further comprises:
forming a splice between a second optical element of the tether and the first optical element of the distribution cable;
positioning the tube and the tether in a second mold; and
injecting the thermoplastic material into the second mold to form a second overmold around respective ends of the tube and the tether.

22. The method of claim 21, wherein the branch cable further comprises a connector and wherein the method further comprises:
coupling the connector to the second optical element of the tether on a distal end of tether.

23. The method of claim 20, further comprising positioning an insert within the opening of the distribution cable such that the end of the branch cable abuts the insert and such that the first optical element is supported by a surface of the insert.
